(19) United States
(12) Patent Application Publication
(10) Pub. No.: US 2024/0242475 A1
(43) Pub. Date: Jul. 18, 2024

(54) LIQUID APPLICATION APPARATUS, LIQUID APPLICATION METHOD, AND NON-TRANSITORY COMPUTER-READABLE MEDIUM

(71) Applicants: Kimiharu YAMAZAKI, Kanagawa (JP); Takashi IKEDA, Kanagawa (JP); Yasunari KAWASHIMA, Kanagawa (JP); Tomoaki KIMURA, Kanagawa (JP); Hideo TANAKA, Kanagawa (JP); Yuta KASHIWAGI, Kanagawa (JP); Masayuki SUNAOSHI, Ibaraki (JP); Yorifumi TSUCHIDA, Kanagawa (JP)

(72) Inventors: Kimiharu YAMAZAKI, Kanagawa (JP); Takashi IKEDA, Kanagawa (JP); Yasunari KAWASHIMA, Kanagawa (JP); Tomoaki KIMURA, Kanagawa (JP); Hideo TANAKA, Kanagawa (JP); Yuta KASHIWAGI, Kanagawa (JP); Masayuki SUNAOSHI, Ibaraki (JP); Yorifumi TSUCHIDA, Kanagawa (JP)

(21) Appl. No.: 18/413,092

(22) Filed: Jan. 16, 2024

(30) Foreign Application Priority Data
Jan. 17, 2023 (JP) 2023-005278
Jan. 17, 2023 (JP) 2023-005284

(51) Int. Cl. G06V 10/75; B41J 2/045; G06V 10/25; G06V 10/98

(52) U.S. Cl. CPC G06V 10/751; B41J 2/04526; G06V 10/25; G06V 10/98

(57) ABSTRACT

A liquid application apparatus sequentially moves to a plurality of regions to which a region to be applied with liquid is divided and discharges liquid on basis of an image pattern corresponding to each of the plurality of regions. The liquid application apparatus includes processing circuitry configured to: calculate a deviation amount between a first region on which an image pattern is applied by the liquid application apparatus and a second region to which the liquid application apparatus moves from the first region; and correct an image pattern corresponding to the second region on basis of the deviation amount calculated.

### CROSS-REFERENCE TO RELATED APPLICATIONS

This patent application is based on and claims priority pursuant to 35 U.S.C. § 119(a) to Japanese Patent Application Nos. 2023-005278, filed on Jan. 17, 2023, and 2023-005284, filed on Jan. 17, 2023, in the Japan Patent Office, the entire disclosure of each of which is hereby incorporated by reference herein.

### BACKGROUND

### Technical Field

Embodiments of the present disclosure relate to a liquid application apparatus, a liquid application method, and a non-transitory computer-readable medium.

### Related Art

In the case of printing a white line, characters, symbols, and so forth on a road surface or the like, a large print region exceeding a movement region of a carriage mounted on a printing apparatus is formed. Therefore, it is necessary to divide the print region, move the printing apparatus itself to each print region to perform printing, and stitch together a plurality of print images. Because it is necessary to accurately stitch together the print images printed in the respective print regions, the positional accuracy in cases where the printing apparatus moves affects the print quality greatly. As a method for estimating the self-position of the printing apparatus, a method for using a speed detector to estimate the current position from the orientation and the rotation amount of the tire, a method for using a global navigation satellite system (GNSS) to estimate the self-position, and the like are known. In addition, an apparatus that performs printing in each print region and then moves to print an image in the next print region, and blurring processing to render the joins between the print regions inconspicuous, are known. However, such blurring processing is confronted by the disadvantage that the joins become conspicuous when the apparatus main body is shifted and has moved to such an extent that the joins are not inconspicuous.

As a technique for making such joins between print images inconspicuous, a technique in which, in order to superimpose high-definition images, correction is performed by measuring a positional deviation amount between image patterns, calculating a correction amount, and pulling or shrinking a printing plate is disclosed.

However, using the above technique, areas outside the printing range of the printing apparatus are not handled, and there are cases where, in printing in a range greater than the printing range, continuous image printing is not performed.

### SUMMARY

According to an embodiment of the present disclosure, a liquid application apparatus sequentially moves to a plurality of regions to which a region to be applied with liquid is divided and discharges liquid on basis of an image pattern corresponding to each of the plurality of regions. The liquid application apparatus includes processing circuitry configured to: calculate a deviation amount between a first region on which an image pattern is applied by the liquid application apparatus and a second region to which the liquid application apparatus moves from the first region; and correct an image pattern corresponding to the second region on basis of the deviation amount calculated.

According to another embodiment of the present disclosure, a liquid application apparatus sequentially moves to each of a plurality of regions into which a region to be applied with liquid is divided and discharges liquid on basis of an image pattern corresponding to each of the plurality of regions. The liquid application apparatus includes processing circuitry to: acquire a first captured image captured by an imaging device before movement of the liquid application apparatus to a target region and a second captured image captured by the imaging device after the movement of the liquid application apparatus to the target region; extract a template image from the first captured image; perform rotation processing to change a relative angle between the second captured image and the template image; perform template matching, using the template image, to the second captured image after the rotation processing; and specify a relative deviation between before and after the movement of the liquid application apparatus on basis of a position of an image portion, in the second captured image after the rotation processing, which matches or is similar to the template image detected by the template matching.

According to still another embodiment of the present disclosure, there is provided a liquid application method for a liquid application apparatus to sequentially move to a plurality of regions to which a region to be applied with liquid is divided and discharge liquid on basis of an image pattern corresponding to each of the plurality of regions. The liquid application method includes calculating and correcting. The calculating calculates a deviation amount between a first region on which an image pattern is applied by the liquid application apparatus and a second region to which the liquid application apparatus moves from the first region. The correcting corrects an image pattern corresponding to the second region on basis of the deviation amount calculated by the calculating.

According to still yet another embodiment of the present disclosure, a non-transitory computer-readable medium storing a plurality of instructions which, when executed by a processor, which is included in a liquid application apparatus that sequentially moves to each region obtained by dividing a liquid coating region into a plurality of regions and discharges liquid on basis of an image pattern corresponding to each of the plurality of regions, to execute calculating and correcting. The calculating calculates a deviation amount between a first region on which an image pattern is applied by the liquid application apparatus and a second region to which the liquid application apparatus moves from the first region. The correcting corrects an image pattern corresponding to the second region on basis of the deviation amount calculated by the calculating.

### BRIEF DESCRIPTION OF THE DRAWINGS

Amore complete appreciation of embodiments of the present disclosure and many of the attendant advantages and features thereof can be readily obtained and understood from the following detailed description with reference to the accompanying drawings, wherein:

FIGS. 1A and 1B are diagrams illustrating an example of an overall configuration of a liquid application apparatus according to an embodiment of the present disclosure;

FIG. 2 is a diagram to illustrate an outline of an operation in a case where a liquid application apparatus according to an embodiment of the present disclosure performs printing outside a carriage scanning range;

FIG. 3 is a diagram illustrating an operation in which a liquid application apparatus according to an embodiment of the present disclosure is moved by a position aligner;

FIGS. 4A to 4G are diagrams illustrating an outline of an entire operation of a liquid application apparatus according to an embodiment of the present disclosure;

FIG. 5 is a diagram illustrating template matching processing according to an embodiment of the present disclosure;

FIG. 6 is a diagram illustrating a hardware configuration of a liquid application apparatus according to an embodiment of the present disclosure;

FIG. 7 is a diagram illustrating an example of a configuration of functional blocks of a liquid application apparatus according to an embodiment of the present disclosure;

FIG. 8 is a diagram illustrating an outline of a correction operation for a print image of a liquid application apparatus according to an embodiment of the present disclosure;

FIG. 9 is a diagram illustrating an outline of template matching/displacement amount specifying processing of a liquid application apparatus according to an embodiment of the present disclosure;

FIG. 10 is a diagram illustrating the degree of similarity in template matching of a liquid application apparatus according to an embodiment of the present disclosure;

FIG. 11 is a flowchart of a process of an entire operation of a liquid application apparatus according to an embodiment of the present disclosure;

FIG. 12 is a flowchart of a process of an entire operation using template matching with respect to a captured image of a liquid application apparatus according to an embodiment of the present disclosure;

FIG. 13 is a flowchart illustrating a process of template matching/displacement amount specifying processing of a liquid application apparatus according to an embodiment of the present disclosure; and

FIG. 14 is a diagram illustrating template matching using a plurality of template images in a liquid application apparatus according to a modification of the above-described embodiments.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, a liquid application apparatus, a liquid application method, a position detection method, and a recording medium according to embodiments of the present disclosure will be described in detail with reference to the drawings. In addition, the present invention is not limited by the following embodiments, and constituent elements in the following embodiments include those that are easily conceived of by those skilled in the art, those that are substantially the same, and those within a so-called equivalent range. Various omissions, substitutions, changes, and combinations of constituent elements are made without departing from the gist of the following embodiments.

In addition, computer software refers to a program pertaining to operation of a computer and is other information used for processing by the computer, and thus is said to be equivalent to a program (hereinafter, computer software is referred to as software). Application software is a generic term for software used to perform a specific operation among software classifications. Meanwhile, an operating system (OS) is software for controlling a computer and allowing application software or the like to use computer resources. An operating system performs basic management and control of a computer, such as control of inputs and outputs, management of hardware such as memory and a hard disk, and process management. Application software operates using functions provided by the operating system. A program is a set of commands to a computer that are combined to achieve one result. An entity which is equivalent to a program does not mean a direct command to a computer and thus such an entity is not called a program, although same possesses properties similar to properties of a program in specifying computer processing. For example, a data structure (a logical structure of data represented by a mutual relationship between data elements) corresponds to a structure equivalent to a program.

### Overall Configuration of Liquid Application Apparatus

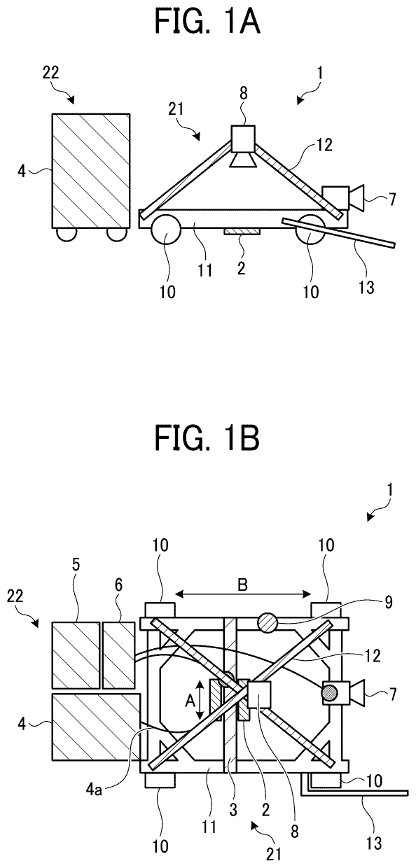

FIGS. 1A and 1B are diagrams illustrating an example of an overall configuration of a liquid application apparatus according to an embodiment. An overall configuration of a liquid application apparatus according to the present embodiment will be described with reference to FIGS. 1A and 1B.

A liquid application apparatus 1 illustrated in FIGS. 1A and 1B is an apparatus that divides a wide liquid application region of a road surface of a road or the like into a plurality of print regions and sequentially moves to each print region, and divides print data for printing on the liquid application region into a plurality of print images for printing. FIG. 1A is a side view of the liquid application apparatus 1, and FIG. 1B is a plan view of the liquid application apparatus 1 as viewed from above. Note that “printing” means applying or spraying ink onto a road, a wall surface, or the like.

As illustrated in FIGS. 1A and 1B, the liquid application apparatus 1 includes a printing unit 21 and a control unit 22. Note that the liquid application apparatus 1 may have a system configuration in which the printing unit 21 and the control unit 22 are separate entities.

The printing unit 21 is a unit that discharges ink while moving to perform printing on a road surface of a road or the like (hereinafter, same may be simply referred to as the “road surface”). Note that “ink” is a liquid applied or sprayed onto the road surface of a road or the like. As illustrated in FIGS. 1A and 1B, the printing unit 21 includes a carriage 2, a rail 3, a three-dimensional camera 7, a two-dimensional camera 8, a GNSS receiver 9, tires 10, a frame 11, a structure 12, and a position aligner 13.

The carriage 2 is a member on which an ink discharge head 2a to be described below is mounted, and which moves in a main scanning direction (arrow A illustrated in FIG. 1B) along the rail 3, and moves in the sub-scanning direction due to the rail 3 moving in the sub-scanning direction (arrow B illustrated in FIG. 1B). The carriage 2 is moved reciprocatingly in the main scanning direction along the rail 3 by a head movement mechanism 23 (see FIG. 6 described below) that includes a belt, a pulley, a motor, and the like.

The rail 3 is a rail member that supports the carriage 2 to move in the main scanning direction and is horizontally supported by the frame 11 so as to be movable in the sub-scanning direction. The rail 3 is moved reciprocatingly on the frame 11 in the sub-scanning direction orthogonal to the main scanning direction by a rail movement mechanism 24 (see FIG. 6 described below) that includes a belt, a pulley, a motor, and the like.

That is, the carriage 2 on which the ink discharge head 2a is mounted moves freely in a front-back direction (sub-scanning direction) and a left-right direction (main scanning direction) on a horizontal plane surrounded by the frame 11 of the liquid application apparatus 1.

The three-dimensional camera 7 is a three-dimensional shape measurement device for peripheral measurement that is supported on a front portion of the frame 11 and that captures images of the surroundings of the liquid application apparatus 1. Note that the three-dimensional camera 7 may be supplied with power from a battery mounted on the three-dimensional camera or, assuming continuous operation, may be supplied with power from a power supply system 5.

The two-dimensional camera 8 is an imaging device that captures images of a road surface and the vicinity of a print image printed on the road surface. Therefore, the imaging direction of the two-dimensional camera 8 is downward. The two-dimensional camera 8 transmits the captured images to a controller unit 6. Note that the two-dimensional camera 8 may be supplied with power from a battery mounted on the two-dimensional camera or, assuming continuous operation, may be supplied with power from the power supply system 5.

The GNSS receiver 9 is a receiver device that receives a positioning signal for measuring, on the basis of the GNSS, a current position on the earth from a positioning satellite. The GNSS receiver 9 transmits the received positioning signal to the controller unit 6.

A plurality of tires 10 is attached to a lower portion of the frame 11 and is members which, when pushed by hand by an operator or the like, serve to move the printing unit 21. Thus, the liquid application apparatus 1 moves in four directions, namely, front, back, left, and right.

The frame 11 is a frame structure that constitutes the base of the printing unit 21 and supports the rail 3, the three-dimensional camera 7, the GNSS receiver 9, the structure 12, and the like from below.

The structure 12 is a structure in which pipes and the like are assembled in a quadrangular pyramid shape. The structure 12 has a two-dimensional camera 8 mounted at the vertex thereof.

The position aligner 13 is a rod-shaped member that is supported on the lateral surface of the frame 11 and that extends toward the front of the printing unit 21. The movement of the liquid application apparatus 1 is guided by aligning the tip of the position aligner 13 with a mark or the like, serving as a target, on the road surface.

As illustrated in FIGS. 1A and 1B, the control unit 22 includes an ink supply system 4, the power supply system 5, and the controller unit 6.

The ink supply system 4 is a unit that supplies ink used for printing to the ink discharge head 2a of the carriage 2 via a pipe 4a constituting the flow path of the ink. In the present embodiment, the ink supply system 4 moves by following the printing unit 21, but is not limited to such movement, and may be self-propelled independently of the printing unit 21.

The power supply system 5 is a unit that supplies power for driving the control unit 22, the head movement mechanism 23, the ink discharge head 2a, and the like.

The controller unit 6 is a control unit for controlling the operation of the liquid application apparatus 1. For example, the controller unit 6 controls the operations of the head movement mechanism 23, the rail movement mechanism 24, and the ink discharge head 2a, and estimates the position of the liquid application apparatus 1 from the positioning signal received by the GNSS receiver 9. The controller unit 6 uses the captured images captured by the three-dimensional camera 7 mainly to avoid contact with an obstacle or the like by using a method such as image correlation, or to estimate the movement amount, posture, or the like of the liquid application apparatus 1. Further, the controller unit 6 stores the positioning signal received by the GNSS receiver 9 as odometry information such as the cumulative movement amount of the liquid application apparatus 1. Note that the liquid application apparatus 1 may include a plurality of GNSS receivers 9, and the controller unit 6 may correct the position information in the light of the positioning signals received by the plurality of GNSS receivers 9.

Note that the liquid application apparatus 1 illustrated in FIGS. 1A and 1B has been described as being moved, in principle, by being pushed by hand by an operator, or the like, but is not limited to such movement. The liquid application apparatus 1 may also be a self-propelled apparatus which includes a motor or the like that controls the rotation of the tires 10.

### Outline of Entire Operation of Liquid Application Apparatus

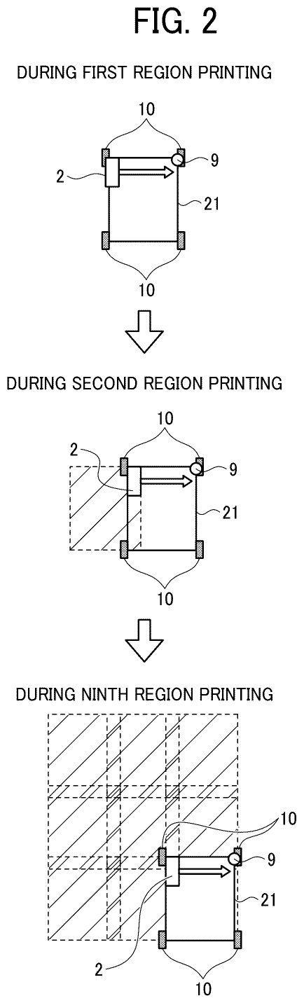

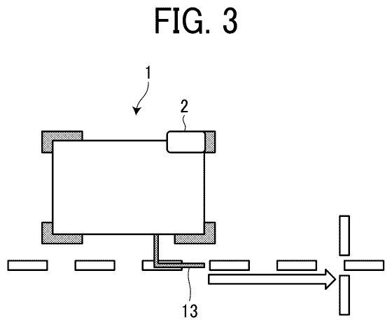

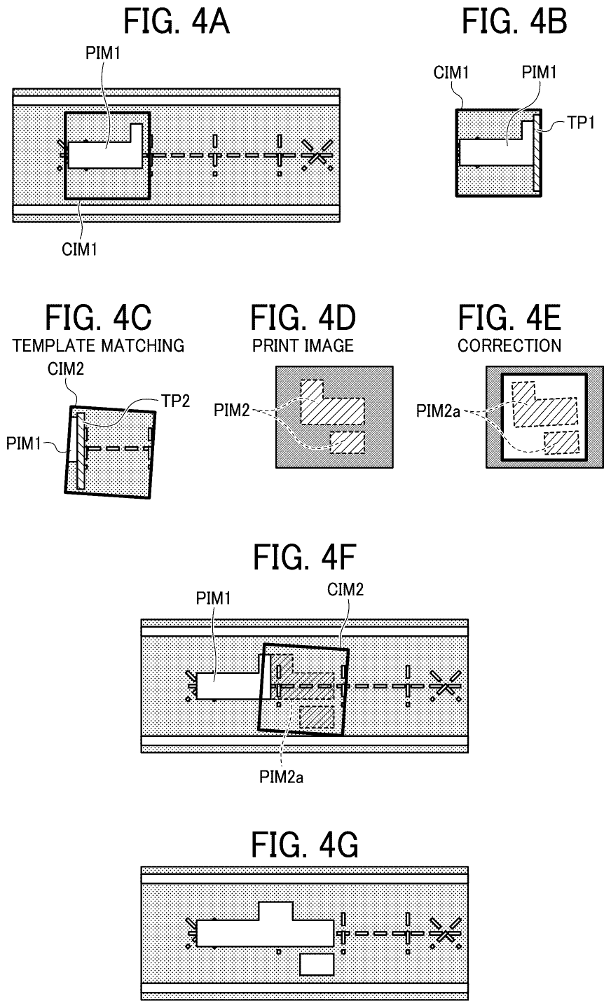

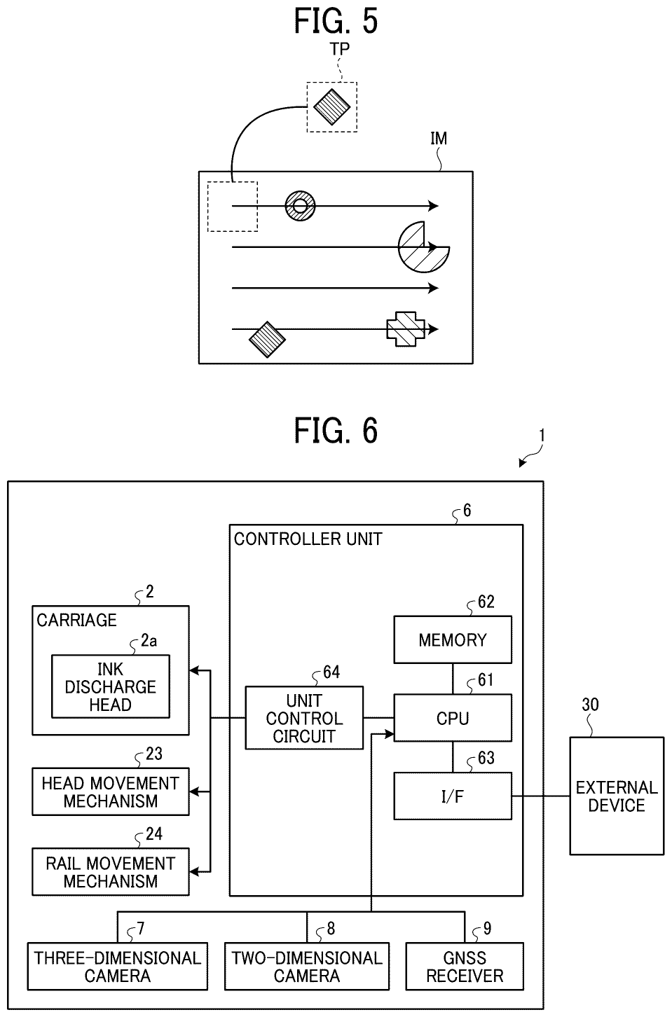

FIG. 2 is a diagram to illustrate an outline of an operation in a case where a liquid application apparatus according to an embodiment of the present disclosure performs printing outside a carriage scanning range. FIG. 3 is a diagram to illustrate an operation of moving the liquid application apparatus according to the present embodiment by a position aligner when the liquid application apparatus is moved. FIGS. 4A to 4G are diagrams illustrating an outline of an entire operation of the liquid application apparatus according to the present embodiment. FIG. 5 is a diagram to illustrate template matching processing. An outline of an entire operation of the liquid application apparatus 1 according to the present embodiment will be described with reference to FIGS. 2 to 5.

As described above, the liquid application apparatus 1 is movable in four directions, namely, front, back, left, and right. That is, the carriage 2 on which the ink discharge head 2a is mounted moves freely in four directions, namely, front, back, left, and right on a horizontal plane surrounded by the frame 11 of the liquid application apparatus 1. Thus, in a case where the ink discharge head 2a is made to perform printing on the road surface outside the scanning range, as illustrated in FIG. 2, the liquid application apparatus 1 divides a liquid application region, which is the entire region to be printed on the road surface, into a plurality of print regions, divides the entire print data to be printed on the liquid applying region into a plurality of print images corresponding to the respective print regions, and prints the respective print images while moving the liquid application region in the front-back direction and the left-right direction and joining the joins so as to make the joins inconspicuous, thereby completing printing of an entire image based on the print data.

Further, the liquid application apparatus 1 according to the present embodiment is moved by hand back and forth and right and left by an operator, and moves with a line, a mark, or the like, which has been drawn with a choke or the like, serving as a mark on the road surface when moving to each print region. Specifically, as illustrated in FIG. 3, the operator moves the tip of the position aligner 13 installed in the liquid application apparatus 1 so as to match the mark from the choke which has been drawn on the road surface, thereby performing printing through ink discharge by the ink discharge head 2a in each print region. As a result, when moving the liquid application apparatus 1, the operator can perform approximate alignment with each print region.

However, in the alignment by the position aligner 13, it is necessary to accurately specify the deviation amount (displacement amount/displacement angle) of the position of the liquid application apparatus 1 after the alignment by the position aligner 13 and correct the print image to be printed by the deviation amount in order to maintain the approximate alignment and render the joins of the print images printed in each print region inconspicuous. Therefore, in the liquid application apparatus 1 according to the present embodiment, the deviation amount (displacement amount/displacement angle) from the ideal position of the liquid application apparatus 1 after the liquid application apparatus 1 is moved to the print region to be printed next is specified, the print image corresponding to the print region is corrected by the deviation amount, and printing is performed on the road surface by using the corrected print image. Here, in order to specify the deviation amount (displacement amount/displacement angle) from the ideal position of the liquid application apparatus 1 after the liquid application apparatus 1 is moved to the print region to be printed next, the deviation amount from the ideal position may be specified (calculated) on the basis of, for example, the position estimated on the basis of the measurement signal received by the GNSS receiver 9, the position detected from the direction of rotation and the rotation amount of the tires 10, or the position of the liquid application apparatus 1 detected and estimated by other sensors. In the present embodiment, as an example of an operation for specifying the deviation amount described above, an operation in which the deviation amount is specified by specifying an image portion which matches the template image by means of template matching with respect to a post-movement captured image using a template image on the captured image captured by the two-dimensional camera 8 before movement will be described in detail. First, with reference to FIGS. 4A to 5, an outline of processing in which a displacement amount and a displacement angle are specified using template matching by the liquid application apparatus 1 (hereinafter, same may be referred to as template matching/displacement amount specifying processing) will be described. Note that, in order to simplify the illustration of FIGS. 4A to 4G, the liquid application apparatus 1 is not illustrated.

As initialization processing, the liquid application apparatus 1 divides a wide liquid application region of a road surface of a road or the like into a plurality of print regions, and divides print data for printing on the liquid application region into a plurality of print images corresponding to each print region. Note that the liquid application apparatus 1 is not limited to dividing the print data into a plurality of print images, rather, for example, the liquid application apparatus 1 may receive, via an interface (I/F) 63, a plurality of print images obtained by dividing the print data in an external device 30, and may use the print images. First, as illustrated in FIG. 4A, in a case where the liquid application apparatus 1 is moved to an initial position, the liquid application apparatus 1 prints the print image PIM1 on the print region corresponding to the initial position. Here, as described above, when the liquid application apparatus 1 moves, the operator moves the tip of the position aligner 13 so as to match the mark drawn on the road surface. The liquid application apparatus 1 then uses the two-dimensional camera 8 to capture the captured image CIM1 with respect to the imaging region of the two-dimensional camera 8 including the print image PIM1.

Next, as illustrated in FIG. 4B, the liquid application apparatus 1 extracts a template image TP1 for performing template matching in a captured image (a captured image CIM2 to be described below) corresponding to the next print region (an example of a target print region) in the captured image CIM1 (an example of a first captured image) which has been captured. Extraction of the template image includes not only actually cutting out the template image as data from the captured image but also specifying a region of the template image in the captured image, and so forth. Here, the extraction of the template image TP1 in the captured image CIM1 is performed from an overlap region between the captured image CIM1 and a captured image corresponding to the next print region (the captured image CIM2 to be described below). This is because, in the captured image CIM2, an image portion which matches or is similar to the template image TP1 extracted from the captured image CIM1 is specified using template matching. Therefore, the imaging regions, which are targets for respective imaging of the adjacent print regions, overlap each other. In the example illustrated in FIGS. 4A to 4G, in order to move the liquid application apparatus 1 from left to right, the region near the right edge of the captured image CIM1 and the region near the left side of the captured image CIM2 illustrated in FIG. 4C overlap each other, and the liquid application apparatus 1 extracts the template image TP1 from the overlap region in the captured image CIM1.

Next, the operator moves the liquid application apparatus 1 to the print region to be printed next. At this time, as described above, because the alignment by the position aligner 13 remains approximate, it is difficult to match the print region where the print image PIM1 has already been printed with the moved print region without any deviation at the joins. Therefore, the liquid application apparatus 1 performs the following processing sequentially.

As illustrated in FIG. 4C, after moving to the print region to be printed next, the liquid application apparatus 1 uses the two-dimensional camera 8 to capture the captured image CIM2 (an example of a second captured image) with respect to the imaging region including the print region. In this case, as described above, because the alignment by the position aligner 13 of the liquid application apparatus 1 remains approximate, the captured image CIM2 illustrated in FIG. 4C is displaced or inclined in comparison with the ideal position with respect to the captured image CIM1 illustrated in FIG. 4B. Therefore, the liquid application apparatus 1 performs template matching to detect, on the captured image CIM2, an image portion which matches or is similar to the template image TP extracted in the captured image CIM1.

Here, the template matching operation will be described with reference to FIG. 5. Template matching is processing to detect, in the image IM to be detected, an image portion which matches or is similar to the target template image TP. In template matching, for example, starting with a comparison between the upper left image portion of the image IM and the template image TP, the degree of similarity, which represents the degree of similarity between the image portion and the template image TP is calculated, and it is determined whether the similarity is a value indicating a match or similarity. The calculation and determination of the degree of similarity are repeatedly performed while the template image TP is raster-scanned on the image IM. Examples of template matching algorithms include sum of squared difference (SSD), sum of absolute difference (SAD), normalized cross correlation (NCC), and zero means normalized cross correlation (ZNCC). At least one of these algorithms may be used. Here, with regard to the degree of similarity, depending on the template matching algorithm, the greater the calculated value, the higher the degree of similarity, or the smaller the calculated value, the higher the degree of similarity. However, in the description of this embodiment, the greater the value of the degree of similarity, the higher the degree of similarity. In the template matching, during the raster scan, the image portion may be determined to be an image portion which matches the template image TP when the calculated degree of similarity exceeds a predetermined threshold value, or the degree of similarity corresponding to all the image portions of the image IM may be calculated, and in a case where the maximum degree of similarity is obtained and that degree of similarity exceeds the predetermined threshold value, the image portion corresponding to that degree of similarity may be determined to be the image portion matching the template image TP.

Returning to FIGS. 4A to 4G, the description will be continued. As described above, in a case where the captured image CIM2 deviates from the ideal position or is inclined, even if template matching is performed while the template image TP1 is raster-scanned on the captured image CIM2 without further processing, an image portion which matches or is similar to the template image TP1 is not detected on the captured image CIM2. Therefore, the liquid application apparatus 1 performs template matching on the rotated captured image CIM2 by using the template image TP while rotating the captured image CIM2 through a predetermined angle. Here, in order to rotate the captured image CIM2, affine transformation or the like may be used, for example. As a result, as illustrated in FIG. 4C, an image portion which matches or is similar to a template image TP1 is detected on the captured image CIM2, and the image portion is set as a comparison image TP2. When the position of the comparison image TP2 serving as an image portion which matches or is similar to the template image TP1 is determined on the captured image CIM2, the positional relationship between the print region in the captured image CIM1 and the template image TP1 is known, and therefore an ideal print region (that is, a print region in the captured image CIM2 having a matching join with the print region of the captured image CIM1) to be printed in the captured image CIM2 is determined with respect to the position of the comparison image TP2 in the captured image CIM2. The liquid application apparatus 1 then specifies (calculates) the deviation amount (displacement amount/displacement angle) of the ideal print region from the print region to be originally printed and determined in the captured image CIM2. As a result, highly accurate detection of the deviation in the relative position and inclination before and after the movement of the liquid application apparatus 1 to perform printing is performed.

Note that, although, in the template matching described above, the template matching is performed while rotating the captured image CIM2, the present invention is not limited to such rotation, and the template matching may be performed while rotating the template image TP1 without further processing of the captured image CIM2. That is, the template matching may be performed while changing the relative angle between the captured image CIM2 and the template image TP1.

Next, on the basis of the specified (calculated) deviation amount (displacement amount/displacement angle), the liquid application apparatus 1 performs correction to move and rotate the print image PIM2 illustrated in FIG. 4D to be printed next as illustrated in FIG. 4E to generate a print image PIM2a. As illustrated in FIG. 4F, the liquid application apparatus 1 then performs printing on the road surface by using the corrected print image PIM2a. As a result, as illustrated in FIG. 4G, the joins between the print image PIM1 printed on the road surface the previous time and the print image PIM2a printed this time are made to substantially match. As described above, by performing printing with the print image corrected on the basis of the specified deviation amount (displacement amount/displacement angle), the joins of each of the printed print images are made inconspicuous.

### Hardware Configuration of Liquid Application Apparatus

FIG. 6 is a diagram illustrating a hardware configuration of a liquid application apparatus according to an embodiment of the present disclosure. A hardware configuration of the liquid application apparatus 1 according to the present disclosure embodiment will be described with reference to FIG. 6.

As illustrated in FIG. 6, the liquid application apparatus 1 includes a carriage 2, a controller unit 6, a three-dimensional camera 7, a two-dimensional camera 8, a GNSS receiver 9, a head movement mechanism 23, and a rail movement mechanism 24.

The carriage 2 has an ink discharge head 2a that discharges ink onto a road surface mounted thereon and moves in the main scanning direction along a rail 3 illustrated in FIGS. 1A and 1B, and the rail 3 moves in the sub-scanning direction by moving in the sub-scanning direction.

The controller unit 6 includes a central processing unit (CPU) 61, a memory 62, the I/F 63, and a unit control circuit 64.

The CPU 61 is an arithmetic device that integrally controls the operation of the liquid application apparatus 1. The CPU 61 performs data communication with the memory 62, the I/F 63, and the unit control circuit 64 via a bus. Furthermore, the CPU 61 performs drive control of the head movement mechanism 23, the rail movement mechanism 24, and the ink discharge head 2a via the unit control circuit 64, and estimates the self-position of the liquid application apparatus 1 from the positioning signal received by the GNSS receiver 9.

The memory 62 is a storage medium such as a read-only memory (ROM) or a random-access memory (RAM) that stores a program used to drive the CPU 61. In addition, the memory 62 is used as a work area of the CPU 61.

The I/F 63 is a communication interface for connecting various external devices 30 such as a tablet terminal, a smartphone, a personal computer (PC), a server, or a laptop PC.

The unit control circuit 64 is a control circuit that controls the operations of the head movement mechanism 23, the rail movement mechanism 24, and the ink discharge head 2a under the control of the CPU 61.

The three-dimensional camera 7 and the two-dimensional camera 8 transmit the captured images to the CPU 61 of the controller unit 6.

The GNSS receiver 9 receives a positioning signal for measuring the current position on the earth from a positioning satellite on the basis of the GNSS, and transmits the positioning signal to the CPU 61 of the controller unit 6.

The head movement mechanism 23 includes a belt, a pulley, a motor, and the like, and is a mechanism that causes the carriage 2 to move reciprocatingly in the main scanning direction along the rail 3 under the control of the unit control circuit 64.

The rail movement mechanism 24 includes a belt, a pulley, a motor, and the like, and is a mechanism that causes the rail 3 to move reciprocatingly on the frame 11 in the sub-scanning direction orthogonal to the main scanning direction under the control of the unit control circuit 64. As a result, the carriage 2 supported by the rail 3 moves reciprocatingly in the sub-scanning direction.

Note that the hardware configuration of the liquid application apparatus 1 illustrated in FIG. 6 is an example, and the liquid application apparatus 1 may include other components.

### Configuration and Operation of Functional Blocks of Liquid Application Apparatus

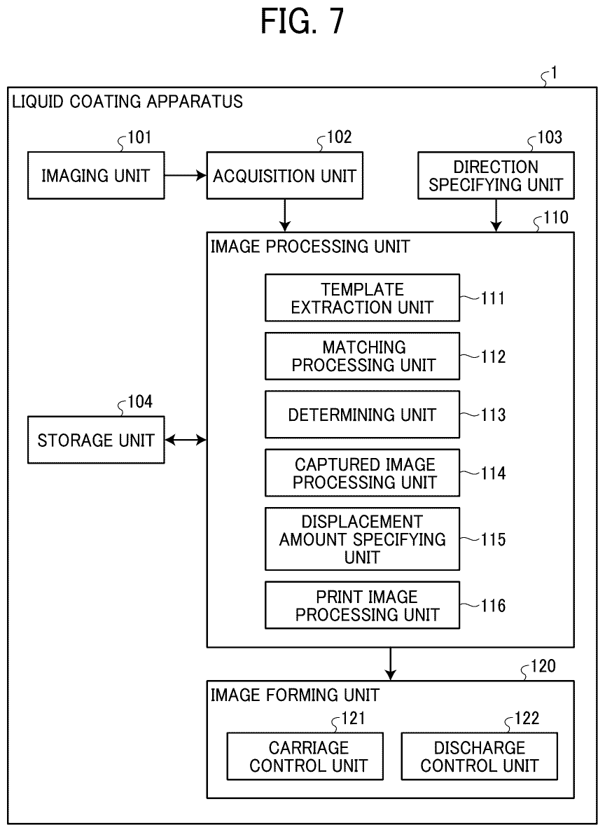

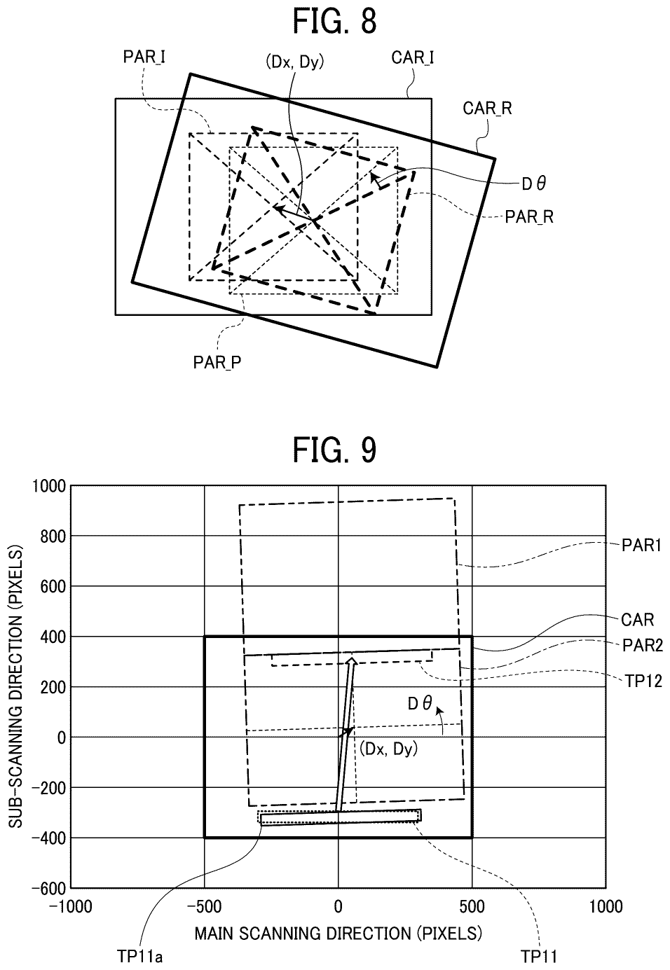

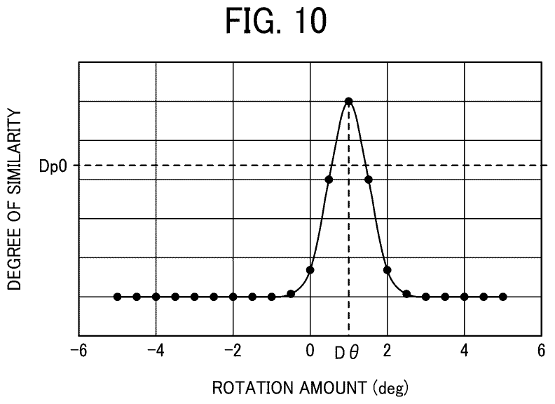

FIG. 7 is a diagram illustrating a configuration of functional blocks of a liquid application apparatus according to an embodiment of the present disclosure. FIG. 8 is a diagram illustrating an outline of a correction operation for a print image of the liquid application apparatus according to the present embodiment. FIG. 9 is a diagram illustrating an outline of the template matching/displacement amount specifying processing of the liquid application apparatus according to the present embodiment. FIG. 10 is a diagram to illustrate degree of similarity in template matching of the liquid application apparatus according to the present embodiment. The configuration and operation of the functional blocks of the liquid application apparatus 1 according to the present embodiment will be described with reference to FIGS. 7 to 10.

As illustrated in FIG. 7, the liquid application apparatus 1 includes an imaging unit 101, an acquisition unit 102, a direction specifying unit 103, a storage unit 104, an image processing unit 110, and an image forming unit 120.

The imaging unit 101 is a functional unit that targets and performs imaging on respective imaging regions including each print region to which the liquid application apparatus 1 has moved. As a result, the imaging unit 101 obtains the captured images obtained by imaging the imaging regions. The imaging unit 101 is implemented by the two-dimensional camera 8 illustrated in FIG. 6.

The acquisition unit 102 is a functional unit that acquires the captured images captured by the imaging unit 101. The acquisition unit 102 is implemented, for example, as a result of a program being executed by the CPU 61 illustrated in FIG. 6.

The direction specifying unit 103 is a functional unit that specifies the direction of movement of the liquid application apparatus 1. For example, the direction specifying unit 103 may specify a fixed direction (for example, a forward direction or the like which is an imaging direction of the three-dimensional camera 7 illustrated in FIGS. 1A and 1B), may specify the direction of movement according to an operation on the liquid application apparatus 1 by an operator, may specify the direction of movement by detecting the orientation and direction of rotation of the tires 10, or may specify the direction of movement in a position of the liquid application apparatus 1 estimated by the positioning signal received by the GNSS receiver 9. The direction specifying unit 103 is implemented, for example, as a result of a program being executed by the CPU 61 illustrated in FIG. 6.

The storage unit 104 is a functional unit that stores print data, a plurality of print images obtained by dividing the print data, a maximum rotation amount θmax and a predetermined rotation amount Δθ to be described below, and information such as displacement amounts Dx and Dy and a displacement angle DO which are specified (calculated) by the image processing unit 110. The storage unit 104 is implemented by the memory 62 illustrated in FIG. 6.

The image processing unit 110 (serving as a calculation unit and a correction unit) is a functional unit that specifies (calculates) a deviation amount from an ideal position by, for example, a position estimated on the basis of a measurement signal received by the GNSS receiver 9, a position detected from a direction of rotation and rotation amounts of the tires 10, a position of the liquid application apparatus 1 detected and estimated by other sensors, image processing with respect to a captured image captured by the imaging unit 101, or the like, and corrects the print image corresponding to the print region by the deviation amount. In the present embodiment, an operation in which the image processing unit 110 particularly specifies (calculates) the deviation amount by image processing including template matching with respect to the captured image captured by the imaging unit 101 will be described.

As described above, in a case where the position aligner 13 is used to move the liquid application apparatus 1 described with reference to FIG. 8 with respect to the deviation amount (displacement amount/displacement angle) on the basis of the captured image, and therefore the liquid application apparatus 1 is moved to the ideal position as the next movement position, the ideal imaging region imaged by the imaging unit 101 is set as an imaging region CAR_I, and the print region determined by the imaging region CAR_I is set as a print region PAR_I. That is, the print region which is connected without deviation with respect to the print region (first print region) where the print image is printed before movement is the print region PAR_I. Therefore, if a corresponding print image is printed on the print region PAR_I by the liquid application apparatus 1, printing is performed in a mode in which the print image printed immediately before and the join are inconspicuous. However, in practice, because it is difficult to move the liquid application apparatus 1 to an ideal position, the imaging region CAR_R actually imaged by the imaging unit 101 has a deviation in position and inclination greater than a deviation in position and inclination of the ideal imaging region CAR_I, as illustrated in FIG. 8. A print region corresponding to the imaging region CAR_R in that case is a print region PAR_R (second print region). Therefore, through image processing that includes template matching with respect to a captured image captured by the image processing unit 110, the image processing unit 110 specifies (calculates) the displacement angle DO, which is the deviation amount of the inclination of the print region PAR_R with respect to the print region PAR_I, and specifies (calculates) the displacement amounts Dx and Dy (hereinafter, same may be referred to as the displacement amounts (Dx, Dy)), which are the deviation amounts of the position of the print region PAR_R with respect to the print region PAR_I, as illustrated in FIG. 8. Here, in FIG. 8, a print region obtained by rotating the print region PAR_R through the displacement angle DO is illustrated as a print region PAR_P. The print region obtained by moving the print region PAR_P by the displacement amount (Dx, Dy) matches the print region PAR_I.

As illustrated in FIG. 7, the image processing unit 110 includes a template extraction unit 111 (serving as an extraction unit), a matching processing unit 112, a determining unit 113, a captured image processing unit 114 (serving as a first image processing unit), a displacement amount specifying unit 115 (serving as a specifying unit or a calculation unit), and a print image processing unit 116 (serving as a second image processing unit or a correction unit). The image processing unit 110 is implemented, for example, as a result of a program being executed by the CPU 61 illustrated in FIG. 6.

The template extraction unit 111 is a functional unit that extracts a template image to be used in the template matching by the matching processing unit 112 from the captured image captured by the image processing unit 110 with respect to the print regions where the print image is printed by the image forming unit 120. For example, as illustrated in FIG. 9, the template extraction unit 111 extracts, as a template image TP11, an image portion in contact with an image portion (that is, a portion of the print image) that corresponds to the print region PART in the specific captured image. In this case, the template extraction unit 111 extracts, as a template image, an image portion that is in contact with the edge (side) on the direction of movement side of the liquid application apparatus 1 specified by the direction specifying unit 103 in an image portion (that is, the portion of the print image) corresponding to the print region in the specific captured image, and that is included in the overlap region between the captured images as described above. As described above, in a case where the template image is extracted on the basis of the direction of movement specified by the direction specifying unit 103, the range in which the template image is extracted is limited, and hence the calculation time is shortened.

Note that, in a case where the template image is extracted from the overlap region in the specific captured image, it is not necessarily limited to extracting, as the template image, an image portion in contact with the image portion corresponding to the print region in the captured image. However, it is desirable for the template image extracted from the overlap area to not include the print image printed in the print region. This is because a state of a color tone or a degree of dryness of a print image printed on a road surface (print region) changes with the lapse of time, and when template matching is executed, an image portion matching a template image including a portion of the print image is not detected from the captured image to be subjected to template matching.

The matching processing unit 112 is a functional unit that executes template matching on a captured image (hereinafter, same may be referred to as a post-movement captured image) (an example of a second captured image) that is moved to a print region to be printed next by the liquid application apparatus 1 and captured with respect to the print region by the imaging unit 101, by using a template image extracted by the template extraction unit 111 from a captured image before movement of the liquid application apparatus 1 (hereinafter, same may be referred to as a pre-movement captured image) (an example of a first captured image). In this case, for the reason described above, the matching processing unit 112 performs template matching, using the template image, on the rotated post-movement captured image while the captured image processing unit 114 rotates the post-movement captured image by the predetermined rotation amount Δθ, which is the unit rotation amount. Here, in the template matching, the matching processing unit 112 performs a raster scan on the template image with respect to the post-movement captured image while calculating a degree of similarity Dp between the image portion of the post-movement captured image and the template image to compare whether the image portions match or are similar to each other.

The determining unit 113 is a functional unit that determines whether or not the degree of similarity Dp calculated by the matching processing unit 112 is greater than a predetermined threshold value Dp0 in template matching performed by the matching processing unit 112 on the post-movement captured image which the captured image processing unit 114 has rotated by the rotation amount θ. Here, the degree of similarity Dp calculated by the matching processing unit 112 may be the maximum degree of similarity among the degrees of similarity between each image portion in the post-movement captured image, which the captured image processing unit 114 has rotated by the rotation amount θ, and the template image. As illustrated in FIG. 10, in a case where it is determined that the degree of similarity Dp is greater than the threshold value Dp0, the determining unit 113 determines that an image portion which matches or is similar to the template image has been detected in the post-movement captured image rotated by the rotation amount θ corresponding to the degree of similarity Dp. FIG. 9 illustrates an example in which a comparison image TP12 is detected as an image portion which matches or is similar to the template image TP11 extracted from the pre-movement captured image, in the post-movement captured image (captured image in an imaging region CAR) rotated by the captured image processing unit 114.

The captured image processing unit 114 is a functional unit that, at the time of template matching by the matching processing unit 112, performs processing to rotate the post-movement captured image by a predetermined rotation amount Δθ. In this case, the captured image processing unit 114 may rotate the post-movement captured image using, for example, affine transformation or the like.

The predetermined rotation amount Δθ is not limited to being fixed, and may be variable. In this case, for example, the predetermined rotation amount Δθ may be variably set by an operation unit included in the liquid application apparatus 1, or the predetermined rotation amount Δθ variably set in the external device 30 may be received by the liquid application apparatus 1 via the I/F 63 and used. As a result, by making the predetermined rotation amount Δθ variable, the predetermined rotation amount Δθ may be adjusted according to the application, for example, a small predetermined rotation amount Δθ enables highly accurate template matching, but increases the calculation time, while a large predetermined rotation amount Δθ makes template matching less accurate, but reduces the calculation time.

The displacement amount specifying unit 115 is a functional unit that, in a case where the determining unit 113 determines that an image portion which matches or is similar to the template image has been detected in the post-movement captured image, specifies, as the displacement angle DO, the rotation amount θ by which the post-movement captured image is rotated by the captured image processing unit 114, as illustrated in FIG. 10. Furthermore, as described above, when the position of the image portion which matches or is similar to the template image is determined in the post-movement captured image, the positional relationship between the print region and the template image in the pre-movement captured image is known, and thus the ideal print region (that is, the print region in the post-movement captured image having a matching join with the print region of the pre-movement captured image) to be printed in the post-movement captured image with respect to the position of the image portion in the post-movement captured image is determined. In the example of FIG. 9, when the position of the comparison image TP 12, which is an image portion that matches or is similar to the template image TP11, is determined in the captured image (post-movement captured image) of the imaging region CAR, the positional relationship between the print region PAR1 and the template image in the pre-movement captured image is known, and thus the ideal print region PAR2 to be printed in the captured image (post-movement captured image) of the imaging region CAR with respect to the position of the comparison image TP12 in the captured image (post-movement captured image) of the imaging region CAR is determined. The displacement amount specifying unit 115 specifies the displacement amount (Dx, Dy) of the above-described ideal print region PAR2 from the original print region determined in the captured image (post-movement captured image) of the imaging region CAR. In this case, the displacement amount specifying unit 115 specifies, as the displacement amount (Dx, Dy), the displacement amount of the center of the print region PAR2 from the center of the original print region (the center of the imaging region CAR) determined in the captured image of the imaging region CAR (the post-movement captured image). The displacement angle DO and the displacement amount (Dx, Dy) which are specified by the displacement amount specifying unit 115 are specified as a relative deviation between before and after the movement of the liquid application apparatus 1.

The print image processing unit 116 is a functional unit that performs correction to move and rotate the print image to be printed in the position where the post-movement captured image of the liquid application apparatus 1 is captured, on the basis of the displacement amount (Dx, Dy) and the displacement angle DO specified (calculated) by the displacement amount specifying unit 115. In this case, the correction by the print image processing unit 116 may be performed using, for example, affine transformation or the like. The image forming unit 120 then performs printing on the road surface by using the print image corrected by the print image processing unit 116. Thus, the joins between the print image printed on the road surface the previous time and the print image printed this time are made to substantially match. As described above, by performing printing with the print image corrected on the basis of the displacement amount (Dx, Dy) and the displacement angle DO specified by the displacement amount specifying unit 115, the joins of each of the printed print images are made inconspicuous.

Note that the print image corrected by the print image processing unit 116 is not limited to being printed to match the edge of the print image previously printed on the road surface, and may be printed in a state of partially overlapping the print image previously printed on the road surface.

The image forming unit 120 is a functional unit that prints a print image on a road surface by performing ink discharge control from the ink discharge head 2a on the basis of the print image corrected by the print image processing unit 116 while moving the carriage 2 in the main scanning direction and the sub-scanning direction. The image forming unit 120 is implemented by the unit control circuit 64 illustrated in FIG. 6. Note that the unit control circuit 64 is illustrated as a hardware circuit in FIG. 6, but is not limited thereto, and may be implemented by the CPU 61 executing a program. In this case, the image forming unit 120 is implemented by the CPU 61 illustrated in FIG. 6 executing a program. As illustrated in FIG. 7, the image forming unit 120 includes a carriage control unit 121 and a discharge control unit 122.

The carriage control unit 121 is a functional unit that controls the head movement mechanism 23 and the rail movement mechanism 24 to control the reciprocating movement in the main scanning direction and the sub-scanning direction of the carriage 2 on which the ink discharge head 2a is mounted. The carriage control unit 121 moves the carriage 2 on the basis of the print image corrected by the print image processing unit 116.

The discharge control unit 122 is a functional unit that controls the ink discharge operation of the ink discharge head 2a. The discharge control unit 122 causes the ink discharge head 2a to discharge ink on the basis of the print image corrected by the print image processing unit 116.

Some or all of the functional units, namely, the acquisition unit 102, the direction specifying unit 103, the template extraction unit 111, the matching processing unit 112, the determining unit 113, the captured image processing unit 114, the displacement amount specifying unit 115, and the print image processing unit 116 may be implemented by a hardware circuit (integrated circuit) such as a field-programmable gate array (FPGA) or an application specific integrated circuit (ASIC) instead of a software program.

In addition, each functional unit of the liquid application apparatus 1 illustrated in FIG. 7 conceptually illustrates a function, and is not limited to such a configuration. For example, a plurality of functional units illustrated as independent functional units in the liquid application apparatus 1 illustrated in FIG. 7 may be configured as one functional unit. On the other hand, in the liquid application apparatus 1 illustrated in FIG. 7, the functions of one functional unit may be divided into a plurality of parts and configured as a plurality of functional units.

### Entire Operation of Liquid Application Apparatus

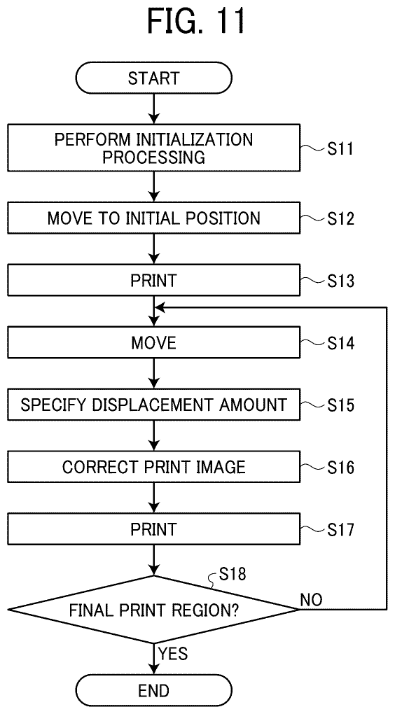

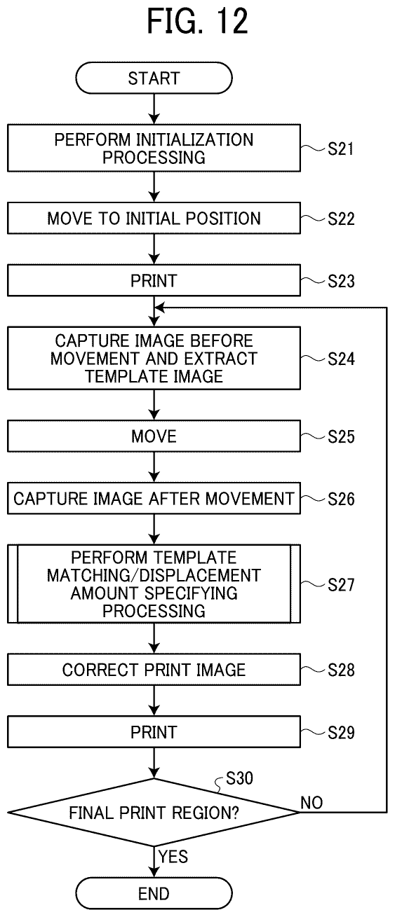

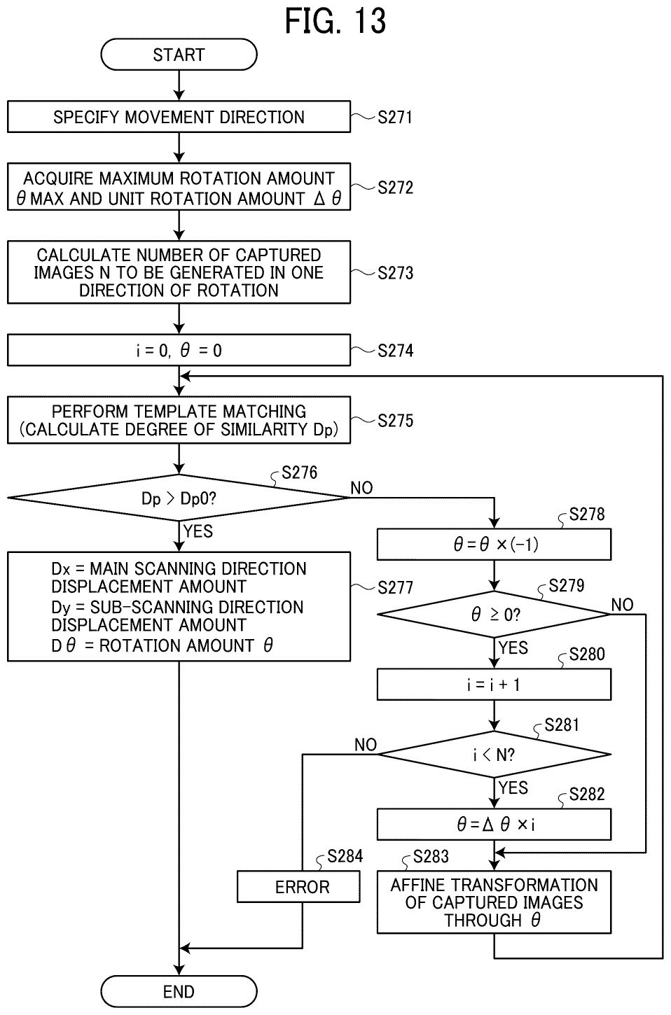

FIG. 11 is a flowchart illustrating a process of the entire operation of a liquid application apparatus according to an embodiment of the present disclosure. FIG. 12 is a flowchart illustrating a process of the entire operation using template matching with respect to a captured image of the liquid application apparatus according to the present embodiment. FIG. 13 is a flowchart illustrating a process of template matching/displacement amount specifying processing of the liquid application apparatus according to the present embodiment. The process of the entire operation of the liquid application apparatus 1 according to the present embodiment will be described with reference to FIGS. 11 to 13.

### Step S11

As initialization processing, the image processing unit 110 of the liquid application apparatus 1 divides a wide liquid application region of a road surface of a road or the like into a plurality of print regions, and divides print data to be printed in the liquid application region into a plurality of print images corresponding to the respective print regions. The processing then advances to step S12.

### Step S12

The operator moves the liquid application apparatus 1 to the initial position so that the tip of the position aligner 13 of the liquid application apparatus 1 matches the mark drawn on the road surface. The processing then advances to step S13.

### Step S13

In the initial position, the image forming unit 120 of the liquid application apparatus 1 prints the print image on the road surface by performing ink discharge control from the ink discharge head 2a on the basis of the print image corresponding to the initial position. The processing then advances to step S14.

### Step S14

The operator moves the tip of the position aligner 13 of the liquid application apparatus 1 to the print region to be printed next so as to match the mark drawn on the road surface. The processing then advances to step S15.

### Step S15

The image processing unit 110 specifies (calculates) a deviation amount from an ideal position using, for example, a position estimated on the basis of a measurement signal received by the GNSS receiver 9, a position detected from the direction of rotation and rotation amounts of the tires 10, a position of the liquid application apparatus 1 detected and estimated by other sensors, image processing with respect to a captured image captured by the imaging unit 101, or the like. The processing then advances to step S16.

### Step S16

The image processing unit 110 performs correction to move and rotate the print image to be set in the print region which has been moved to, on the basis of the specified (calculated) deviation amount. The processing then advances to step S17.

### Step S17

While moving the carriage 2 in the main scanning direction and the sub-scanning direction, the image forming unit 120 of the liquid application apparatus 1 performs ink discharge control from the ink discharge head 2a on the basis of the print image corrected by the image processing unit 110, thereby printing the print image on the road surface. The processing then advances to step S18.

### Step S18

The image processing unit 110 checks whether or not printing has been completed for all the divided print regions, up to the final print region. In a case where printing has not been completed up to the final print region (step S18: No), the processing returns to step S14, and in a case where printing has been completed up to the final print region (step S18: Yes), the entire operation (printing operation) of the liquid application apparatus 1 is terminated.

Next, with reference to FIG. 12, the flow of an operation will be described in which an image portion matching the template image is specified by means of template matching with respect to the post-movement captured image by using the template image on the captured image captured by the two-dimensional camera 8 before the movement, thereby specifying a post-movement deviation amount of the liquid application apparatus 1, and on the basis of the deviation amount, the print image is corrected and printing is performed.

### Step S21

As initialization processing, the image processing unit 110 of the liquid application apparatus 1 divides a wide liquid application region of a road surface of a road or the like into a plurality of print regions, and divides print data to be printed in the liquid application region into a plurality of print images corresponding to the respective print regions. The processing then advances to step S22.

### Step S22

The operator moves the liquid application apparatus 1 to the initial position so that the tip of the position aligner 13 of the liquid application apparatus 1 matches the mark drawn on the road surface. In this case, the direction specifying unit 103 of the liquid application apparatus specifies the direction of movement of the liquid application apparatus 1. The processing then advances to step S23.

### Step S23

In the initial position, the image forming unit 120 of the liquid application apparatus 1 prints the print image on the road surface by performing ink discharge control from the ink discharge head 2a on the basis of the print image corresponding to the initial position. Here, the print image is data obtained by dividing the print data as described above. That is, the processing then advances to step S24.

### Step S24

The imaging unit 101 of the liquid application apparatus 1 captures an image in an imaging range that includes a print region where a print image is printed by the image forming unit 120 to obtain a captured image (pre-movement captured image). The acquisition unit 102 of the liquid application apparatus 1 then acquires the pre-movement captured image captured by the imaging unit 101. The template extraction unit 111 of the image processing unit 110 then extracts a template image to be used in template matching by the matching processing unit 112 from the pre-movement captured image acquired by the acquisition unit 102. In this case, the template extraction unit 111 extracts the template image from the pre-movement captured image on the basis of the direction of movement of the liquid application apparatus 1 specified by the direction specifying unit 103. Here, the reason why the imaging unit 101 obtains the captured image (pre-movement captured image) by imaging an imaging range that includes the print region after printing, instead of before the print image is printed by the image forming unit 120, is to perform imaging in a determined position after the printing operation because the position of the liquid application apparatus 1 may be displaced by the printing operation by the image forming unit 120.

Note that, as described above, the pre-movement captured image captured after printing is used as an extraction target of the template image, but the extraction target is not limited thereto. That is, the template image may be extracted from the captured image captured before printing in the print region as long as the positional deviation due to the printing operation as described above is acceptable.

The processing then advances to step S25.

### Step S25

The operator moves the tip of the position aligner 13 of the liquid application apparatus 1 to the print region to be printed next so as to match the mark drawn on the road surface. The processing then advances to step S26.

### Step S26

The imaging unit 101 then images an imaging range that includes the print region which has been moved to, and thus obtains a captured image (post-movement captured image). The acquisition unit 102 acquires the post-movement captured image captured by the imaging unit 101. The processing then advances to step S27.

### Step S27

The image processing unit 110 then executes the template matching/displacement amount specifying processing illustrated in FIG. 13. Hereinafter, the flow of the template matching/displacement amount specifying processing will be described with reference to FIG. 13.

### Step S271

The direction specifying unit 103 specifies the direction of movement of the liquid application apparatus 1. The processing then advances to step S272.

### Step S272

The image processing unit 110 acquires the maximum rotation amount θmax and the predetermined rotation amount Δθ which are stored in the storage unit 104. The processing then advances to step S273.

### Step S273

The image processing unit 110 calculates the number of images N of the rotated post-movement captured image, which is generated in a case where the post-movement captured image is rotated in a specific direction of rotation, by the maximum rotation amount θmax/the predetermined rotation amount Δθ. The processing then advances to step S274.

### Step S274

The image processing unit 110 resets the counter variable i and the rotation amount θ indicating the amount of rotation of the post-movement captured image to zero. The processing then advances to step S275.

### Step S275

The matching processing unit 112 of the image processing unit 110 uses the template image extracted by the template extraction unit 111 to perform template matching on the post-movement captured image. Here, in a case where the processing has passed through step S283, the matching processing unit 112 uses the template image to execute template matching on the post-movement captured image which the captured image processing unit 114 has rotated by the rotation amount θ. Here, in the template matching, the matching processing unit 112 performs a raster scan on the template image with respect to the post-movement captured image while calculating a degree of similarity Dp between the image portion of the post-movement captured image and the template image to compare whether the image portions match or are similar to each other. Here, the degree of similarity Dp calculated by the matching processing unit 112 may be the maximum degree of similarity among the degrees of similarity between each image portion in the post-movement captured image, which the captured image processing unit 114 has rotated by the rotation amount θ, and the template image. The processing then advances to step S276.

### Step S276

The determining unit 113 of the image processing unit 110 determines, in the template matching performed by the matching processing unit 112 on the post-movement captured image, whether or not the degree of similarity Dp calculated by the matching processing unit 112 is greater than a predetermined threshold value Dp0. In a case where the degree of similarity Dp is greater than the threshold value Dp0 (step S276: Yes), the determining unit 113 determines that an image portion which matches or is similar to the template image has been detected in the post-movement captured image rotated by the rotation amount θ corresponding to the degree of similarity Dp, and advances to step S277. On the other hand, in a case where the degree of similarity Dp is equal to or less than the threshold value Dp0 (step S276: No), the processing advances to step S278.

### Step S277

In a case where the determining unit 113 determines that an image portion which matches or is similar to the template image has been detected in the post-movement captured image, the displacement amount specifying unit 115 of the image processing unit 110 specifies, as the displacement angle DO, the rotation amount θ by which the post-movement captured image is rotated by the captured image processing unit 114. Furthermore, when the position of the image portion which matches or is similar to the template image is determined in the post-movement captured image, the positional relationship between the print region in the pre-movement captured image and the template image is known, and thus the ideal print region (that is, the print region in the post-movement captured image having a matching join with the print region of the pre-movement captured image) to be printed in the post-movement captured image with respect to the position of the image portion in the post-movement captured image is determined. The displacement amount specifying unit 115 then specifies the displacement amount (Dx, Dy) of the above-described ideal print region from the original print region determined in the post-movement captured image. The displacement amount specifying unit 115 then ends the template matching/displacement amount specifying processing.

### Step S278

The image processing unit 110 inverts the sign of the rotation amount θ by multiplying the rotation amount θ by −1. The processing then advances to step S279.

### Step S279

As a result, the image processing unit 110 determines whether or not the rotation amount θ is 0 or more. In a case where the rotation amount θ is 0 or more (step S279: Yes), the processing advances to step S280. In a case where the rotation amount θ is less than 0, that is, in a case where the rotation amount θ is a negative number (step S279: No), the processing advances to step S283.

### Step S280

The image processing unit 110 increments the counter variable i. The processing then advances to step S281.

### Step S281

The image processing unit 110 determines whether or not the counter variable i is less than the number of images N. That is, the image processing unit 110 determines whether template matching has not yet been completed until a post-movement captured image in a state of bidirectional rotation up to the maximum rotation amount θmax is rendered. In a case where the counter variable i is less than the number of images N (step S281: Yes), the processing advances to step S282, and in a case where the counter variable i is the number of images N or more (step S281: No), the processing advances to step S284.

### Step S282

The image processing unit 110 sets, as the rotation amount θ, a value obtained by multiplying the predetermined rotation amount Δθ by the counter variable i. The processing then advances to step S283.

### Step S283

The captured image processing unit 114 of the image processing unit 110 performs image processing to rotate the post-movement captured image by the rotation amount θ. In this case, the captured image processing unit 114 may rotate the post-movement captured image by using, for example, affine transformation or the like. The processing then returns to step S275.

In this manner, the captured image processing unit 114 rotates the post-movement captured image by a plurality of rotation amounts in the order of θ=Δθ, −Δθ, 2Δθ, −2Δθ, 3Δθ, and −3Δθ from the state of the rotation amount θ=0 (state without rotation), that is, in the order in which the absolute value of the rotation amount θ gradually increases while reversing the direction of rotation, and the rotated image is used in the template matching by the matching processing unit 112. As a result, it is possible to perform early detection of an image portion which matches or is similar to the template image in the post-movement captured image.

### Step S284

In a case where the counter variable i is the number of images N or more, the image processing unit 110 performs error processing on the assumption that an image portion which matches or is similar to the template image is not detected in the post-movement captured image even if template matching is performed until the post-movement captured image in a state of bidirectional rotation up to the maximum rotation amount θmax is rendered. As error processing, the image processing unit 110 performs processing such as causing a display unit (for example, an indicator lamp) provided in the liquid application apparatus 1 to display an error or transmitting information including information indicating an error to the external device 30 via the I/F 63, for example. As a result, the operator is prompted to review the position of the liquid application apparatus 1. In addition, as described above, the reason why the limit is set to the maximum rotation amount θmax with respect to the bidirectional rotation of the post-movement captured image is that, in order to perform the template matching by rotating the post-movement captured image by each predetermined rotation amount Δθ within a full 360 degree rotation, the calculation load becomes large and the calculation time is then long. The displacement amount specifying unit 115 then ends the template matching/displacement amount specifying processing.

After the template matching/displacement amount specifying processing by the image processing unit 110 ends, the processing advances to step S28. Here, the description is provided based on the assumption that an image portion which matches or is similar to the template image has been detected in the post-movement captured image, and that the displacement amount (Dx, Dy) and the displacement angle DO are specified by the displacement amount specifying unit 115.

### Step S28

On the basis of the displacement amount (Dx, Dy) and the displacement angle DO specified (calculated) by the displacement amount specifying unit 115, the print image processing unit 116 of the image processing unit 110 performs correction to move and rotate the print image to be printed in the position where the post-movement captured image is captured. The processing then advances to step S29.

### Step S29

While moving the carriage 2 in the main scanning direction and the sub-scanning direction in the position where the post-movement captured image is captured, the image forming unit 120 performs ink discharge control from the ink discharge head 2a on the basis of the print image corrected by the print image processing unit 116, and thus prints the print image on the road surface. The processing then advances to step S30.

### Step S30

The image processing unit 110 checks whether or not printing has been completed for all the divided print regions, up to the final print region. In a case where printing has not been completed up to the final print region (step S30: No), the processing returns to step S24, and in a case where printing has been completed up to the final print region (step S30: Yes), the image processing unit 110 ends the entire operation (printing operation) of the liquid application apparatus 1.

As a technique for making joins between print images inconspicuous, for example, a technique has been proposed in which, in order to superimpose high-definition images, correction is performed by measuring a positional deviation amount between image patterns, calculating a correction amount, and pulling or shrinking a printing plate.

However, using the above technique, areas outside the printing range of the printing apparatus are not handled, and there are cases where, in printing in a range greater than the printing range, continuous image printing is not performed.

As described above, in the liquid application apparatus 1 according to the present embodiment, the liquid application region is sequentially moved to each of the plurality of divided print regions, and the liquid is discharged on the basis of the print image corresponding to each of the print regions. The image processing unit 110 calculates the deviation amount between the first print region on which the print image is printed by the liquid application apparatus 1, and the second print region when the liquid application apparatus 1 moves from the first print region, and corrects the print image corresponding to the second print region on the basis of the calculated deviation amount. By using print images which have been thus corrected, it is possible to render seams between images, printed by the liquid application apparatus 1 that itself moves, inconspicuous.

In addition, in the above-described technique, there is a disadvantage in that no consideration has been paid to correcting the deviation in relative position and inclination before and after movement of an apparatus which itself moves.

However, according to an embodiment of the present disclosure, it is possible to perform highly accurate detection of a relative deviation between before and after movement of an apparatus that itself moves to perform printing.

As described above, in the liquid application apparatus 1 according to the present embodiment, the acquisition unit 102 acquires the pre-movement captured image captured by the imaging unit 101 before the liquid application apparatus 1 moves to the target print region and the post-movement captured image captured by the imaging unit 101 after the liquid application apparatus 1 moves to the target print region, the template extraction unit 111 extracts the template image from the pre-movement captured image, the captured image processing unit 114 performs the rotation processing so as to change the relative angle between the post-movement captured image and the template image, the matching processing unit 112 uses the template image to perform the template matching on the post-movement captured image after the rotation processing, and the displacement amount specifying unit 115 specifies the relative deviation between before and after the movement of the liquid application apparatus 1 on the basis of the position of an image portion, in the post-movement captured image after the rotation processing, which matches or is similar to the template image detected by the template matching. As a result, it is possible to perform highly accurate detection of a relative deviation between before and after the movement of the liquid application apparatus 1 that itself moves to perform printing.

Further, in the liquid application apparatus 1 according to the present embodiment, the print image processing unit 116 corrects the print image to be printed in the target print region on the basis of the deviation specified by the displacement amount specifying unit 115, and the image forming unit 120 performs printing in the target print region on the basis of the print image corrected by the print image processing unit 116. Thus, the joins of the printed print images are made inconspicuous.

### Modification

A liquid application apparatus 1 according to a modification will be described by focusing on the differences from the liquid application apparatus 1 according to the above-described embodiment. In the above-described embodiment, an operation in which one template image was extracted from a pre-movement captured image and template matching was executed using the template image was described. In this modification, an operation in which a plurality of template images is extracted from the pre-movement captured image and template matching is executed using the plurality of template images will be described. Note that the overall configuration, the hardware configuration, and the configuration of the functional blocks of the liquid application apparatus 1 according to this modification are similar to the overall configuration, the hardware configuration, and the configuration of the functional blocks of the liquid application apparatus 1 according to the above-described embodiment.

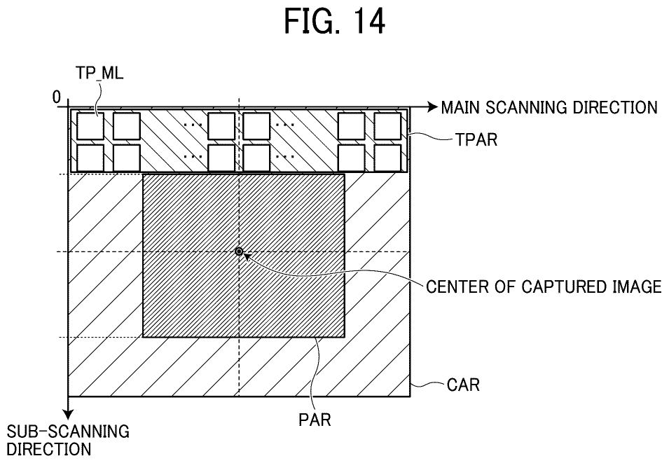

FIG. 14 is a diagram to illustrate template matching using a plurality of template images in a liquid application apparatus according to a modification. The template matching/displacement amount specifying processing by the liquid application apparatus 1 according to this modification will be described with reference to FIG. 14.

The template extraction unit 111 extracts a plurality of template images to be used in the template matching by the matching processing unit 112 from the captured image (pre-movement captured image) captured by the image processing unit 110 with respect to the print regions where the print images are printed by the image forming unit 120. In this case, the template extraction unit 111 extracts a plurality of template images from an image region (template image region) that is in contact with the edge (side) on the direction of movement side of the liquid application apparatus 1 specified by the direction specifying unit 103, in the image portion (that is, the portion of the print image) corresponding to the print region in the pre-movement captured image, and which image region is included in the overlap region between the captured images as described earlier. For example, as illustrated in FIG. 14, in a case where the imaging region CAR is the pre-movement captured image and the direction of movement of the liquid application apparatus 1 specified by the direction specifying unit 103 is an upward direction in a sheet view of FIG. 14, the template extraction unit 111 extracts a plurality of template images TP_ML from the template image region TPAR, which is an image region in contact with the upper edge (upper side) of the print region included in the imaging region CAR.

Note that, in the example illustrated in FIG. 14, a plurality of template images TP_ML which do not overlap (overlap) each other are extracted by the template extraction unit 111 from the template image region TPAR, but the present invention is not limited to such images, rather, template images TP_ML among which there are at least some overlapping images may be used.

The matching processing unit 112 is moved to the print region to be printed next by the liquid application apparatus 1, and executes template matching on the post-movement captured image, which the imaging unit 101 has captured with respect to the print region, by using a plurality of template images extracted by the template extraction unit 111 from the pre-movement captured image. In this case, the matching processing unit 112 performs template matching using a plurality of template images on the rotated post-movement captured image while the captured image processing unit 114 rotates the post-movement captured image by a predetermined rotation amount Δθ which is a predetermined angle. Here, in the template matching, while raster-scanning a plurality of template images with respect to the post-movement captured image, the matching processing unit 112 calculates each degree of similarity Dp between the image portion of the post-movement captured image and the plurality of template images to compare whether the image portions match or are similar to each other. In this case, the matching processing unit 112 determines, as the degree of similarity Dp corresponding to the post-movement captured image rotated by the specific rotation amount θ, any one of a median, a minimum value, a maximum value, an average value, or the like, for example, among the degrees of similarity Dp corresponding to the plurality of template images calculated for the post-movement captured image rotated by the specific rotation amount θ.

In the template matching with respect to the post-movement captured image which the captured image processing unit 114 has rotated by the rotation amount θ, the determining unit 113 determines whether or not a degree of similarity Dp which has been determined by the matching processing unit 112 to correspond to the post-movement captured image rotated by the rotation amount θ is greater than a predetermined threshold value Dp0. In a case where it is determined that the degree of similarity Dp is greater than the threshold value Dp0, the determining unit 113 determines that an image portion which matches or is similar to any one of the plurality of template images has been detected in the post-movement captured image rotated by the rotation amount θ corresponding to the degree of similarity Dp.

At the time of template matching by the matching processing unit 112, the captured image processing unit 114 performs image processing to rotate the post-movement captured image by a predetermined rotation amount Δθ. In this case, the captured image processing unit 114 may rotate the post-movement captured image by using, for example, affine transformation or the like.

In a case where the determining unit 113 determines that an image portion which matches or is similar to any of the plurality of template images has been detected in the post-movement captured image, the displacement amount specifying unit 115 specifies, as the displacement angle DO, the rotation amount θ by which the post-movement captured image has been rotated by the captured image processing unit 114. Furthermore, as described above, when the position of the image portion which matches or is similar to any of the template images is determined in the post-movement captured image, the positional relationship between the print region in the pre-movement captured image and the template image is known, and therefore the ideal print region (that is, the print region in the post-movement captured image having a matching join with the print region of the pre-movement captured image) to be printed in the post-movement captured image with respect to the position of the image portion in the post-movement captured image is determined. In the example of FIG. 9, when the position of the comparison image TP 12, which is an image portion which matches or is similar to the template image TP11, is determined in the captured image (post-movement captured image) of the imaging region CAR, the positional relationship between the print region PART and the template image in the pre-movement captured image is known, and thus the ideal print region PAR2 to be printed in the captured image (post-movement captured image) of the imaging region CAR with respect to the position of the comparison image TP12 in the captured image (post-movement captured image) of the imaging region CAR is determined. The displacement amount specifying unit 115 then specifies the displacement amount (Dx, Dy) of the ideal print region from the original print region determined in the post-movement captured image. In this case, the displacement amount specifying unit 115 specifies, as the displacement amount (Dx, Dy), the displacement amount of the center of the ideal print region from the center of the original print region (the center of the imaging region CAR) determined in the post-movement captured image.

On the basis of the displacement amount (Dx, Dy) and the displacement angle DO specified (calculated) by the displacement amount specifying unit 115, the print image processing unit 116 performs correction to move and rotate the print image to be printed in the position where the post-movement captured image of the liquid application apparatus 1 is captured. In this case, the correction by the print image processing unit 116 may be performed using, for example, affine transformation or the like. The image forming unit 120 then performs printing on the road surface by using the print image corrected by the print image processing unit 116.

The captured image captured by the imaging unit 101 (two-dimensional camera 8) may include glare due to errors due to the contamination of foreign matter or aberration of the lens of the two-dimensional camera 8. Therefore, as described above, a plurality of template images is extracted from the template image region of the pre-movement captured image by the template extraction unit 111, and template matching using the plurality of template images is performed by the matching processing unit 112, and therefore the displacement amount (Dx, Dy) and the displacement angle DO are specified, and the print image is corrected and printed on the basis of the specified displacement amount and displacement angle DO. As a result, the influence of the above-described error is reduced.

In the above-described embodiments and modification, in a case where at least one of the functions of the liquid application apparatus 1 is implemented by executing a program, the program is provided by being incorporated in advance in a ROM or the like. Further, in the above-described embodiment and modification, the program executed by the liquid application apparatus 1 may be provided, as a file in an installable format or an executable format, by being recorded on a computer-readable recording medium such as a compact disc read only memory (CD-ROM), a flexible disk (FD), a compact disk-recordable (CD-R), or a digital versatile disc (DVD). In the above-described embodiments and modification, the program executed by the liquid application apparatus 1 may be stored in a computer connected to a network such as the Internet and provided by being downloaded via the network. In the above-described embodiments and modification, the program executed by the liquid application apparatus 1 may be provided or distributed via a network such as the Internet. Furthermore, in the above-described embodiment and modification, the program executed by the liquid application apparatus 1 has a module configuration including at least one of the above-described functional units, and as actual hardware, the CPU reads and executes the program from the above-described storage device, and thus the above-described functional units are loaded and generated on the main storage device.

Aspects of the present disclosure are as follows.

### First Aspect

According to a first aspect, a liquid application apparatus (e.g., the liquid application apparatus 1) sequentially moves to each of a plurality of regions (e.g., print regions) to which a region (e.g., liquid application region) to be applied with liquid is divided and discharges liquid on basis of an image pattern (e.g., print image) corresponding to each of the plurality of regions (e.g., print regions). The liquid application apparatus includes a calculation unit and a correction unit. The calculation unit calculates a deviation amount between a first region (e.g., first print region) on which an image pattern (e.g., print image) is applied (e.g., printed) by the liquid application apparatus and a second region (e.g., second print region) to which the liquid application apparatus moves from the first region. The correction unit corrects an image pattern (e.g., print image) corresponding to the second region on basis of the deviation amount calculated by the calculation unit.

### Second Aspect

According to a second aspect, the liquid application apparatus of the first aspect further includes an image forming unit that applies liquid (e.g., performs printing) on basis of the image pattern corrected by the correction unit.

### Third Aspect

According to a third aspect, in the liquid application apparatus of the first or second aspect, the calculation unit calculates, as the deviation amount, a displacement amount and a displacement angle of the second region (e.g., second print region) with respect to the first region (e.g., first print region).

### Fourth Aspect

According to a fourth aspect, the liquid application apparatus of any one of the first to third aspects further includes an acquisition unit. The acquisition unit acquires a first captured image captured, in the first region of the liquid application apparatus, by an imaging unit and a second captured image captured, in the second region of the liquid application apparatus, by the imaging unit. The calculation unit calculates the deviation amount on basis of the first captured image and the second captured image acquired by the acquisition unit.

### Fifth Aspect

According to a fifth aspect, the liquid application apparatus of any one of the first to fourth aspects further includes a position aligner to guide movement of the liquid application apparatus to each of the plurality of regions.

### Sixth Aspect

According to a sixth aspect, the liquid application apparatus of any one of the first to fifth aspects further includes a direction specifying unit to specify a direction of movement of the liquid application apparatus. the calculation unit calculates the deviation amount on basis of the direction of movement.

### Seventh Aspect

According to a seventh aspect, a liquid application method is provided for a liquid application apparatus that sequentially moves to each of a plurality of regions (e.g., print regions) to which a region (e.g., liquid application region) to be applied with liquid is divided and discharges liquid on basis of an image pattern (e.g., print image) corresponding to each of the plurality of regions. The liquid application method includes calculating and correcting. The calculating calculates a deviation amount between a first region (e.g., first print region) on which an image pattern (e.g., print image) is applied (e.g., printed) by the liquid application apparatus and a second region (e.g., second print region) to which the liquid application apparatus moves from the first region. The correcting corrects an image pattern corresponding to the second region on basis of the deviation amount calculated by the calculating.

### Eighth Aspect

According to an eighth aspect, a program causes a computer included in a liquid application apparatus that sequentially moves to each a plurality of regions to which a region (e.g., liquid application region) to be applied with liquid is divided and discharges liquid on basis of an image pattern (e.g., print image) corresponding to each of the plurality of regions to execute calculating and correcting. The calculating calculates a deviation amount between a first region (e.g., first print region) on which an image pattern (e.g., print image) is applied (e.g., printed) by the liquid application apparatus and a second region (e.g., second print region) to which the liquid application apparatus moves from the first region. The correcting corrects an image pattern (e.g., print image) corresponding to the second region on basis of the deviation amount calculated by the calculating.

### Ninth Aspect

According to a ninth aspect, a liquid application apparatus (e.g., the liquid application apparatus 1) sequentially moves to each of a plurality of regions to which a region (e.g., liquid application region) to be applied with liquid is divided and discharges liquid on basis of an image pattern (e.g., print image) corresponding to each of the plurality of regions. The liquid application apparatus includes an acquisition unit, an extraction unit, a first image processing unit, a matching processing unit, and a specifying unit. The acquisition unit acquires a first captured image captured by an imaging unit before movement of the liquid application apparatus to a target region (e.g., target print region) and a second captured image captured by the imaging unit after the movement of the liquid application apparatus to the target region. The extraction unit extracts a template image from the first captured image. The first image processing unit performs rotation processing to change a relative angle between the second captured image and the template image. The matching processing unit performs template matching, using the template image, to the second captured image after the rotation processing. The specifying unit specifies a relative deviation between before and after the movement of the liquid application apparatus on basis of a position of an image portion, in the second captured image after the rotation processing, which matches or is similar to the template image detected by the template matching.

### Tenth Aspect

According to a tenth aspect, the liquid application apparatus of the ninth aspect further includes a second image processing unit and an image forming unit. The second image processing unit corrects the image pattern to be applied to the target region, on basis of the deviation specified by the specifying unit. The image forming unit applies liquid (e.g., performs printing) in the target region on basis of the image pattern corrected by the second image processing unit.

### Eleventh Aspect

According to an eleventh aspect, in the liquid application apparatus of the ninth or tenth aspect, the specifying unit specifies a rotation amount in the rotation processing as a displacement angle of a position of the target region after movement of the liquid application apparatus with respect to a position of the target region of the liquid application apparatus, and as a displacement amount from the target region determined on basis of a position of the image portion detected in the second captured image in the target region included in the second captured image.

### Twelfth Aspect

According to a twelfth aspect, in the liquid application apparatus of any one of the ninth to eleventh aspects, the first image processing unit performs the rotation processing on the second captured image.

### Thirteenth Aspect

According to a thirteenth aspect, in the liquid application apparatus of the twelfth aspect, the first image processing unit performs the rotation processing on the second captured image by using each of a plurality of rotation amounts.

### Fourteenth Aspect

According to a fourteenth aspect, in the liquid application apparatus of any one of the ninth to thirteenth aspects, the extraction unit extracts the template image from an image portion of the first captured image overlapping with the second captured image.

### Fifteenth Aspect

According to a fifteenth aspect, in the liquid application apparatus of the fourteenth aspect, the extraction unit extracts the template image from the first captured image so that the template image does not include an image pattern that has been applied to a region (e.g., print region) of the liquid application apparatus before the liquid application apparatus moves to the target region (e.g., target print region).

### Sixteenth Aspect

According to a sixteenth aspect, the liquid application apparatus of any one of the ninth to fifteenth aspects further includes a direction specifying unit to specify a direction of movement of the liquid application apparatus. The extraction unit extracts the template image from the second captured image on basis of the direction of movement specified by the direction specifying unit.

### Seventeenth Aspect

According to a seventeenth aspect, in the liquid application apparatus of the tenth aspect, the acquisition unit acquires the first captured image including the region on which the image pattern is applied. The first captured image is captured by the imaging unit after the image forming unit applies liquid based on the image pattern.

### Eighteenth Aspect

According to an eighteenth aspect, in the liquid application apparatus of the eleventh aspect, the extraction unit extracts a plurality of template images, including the template image, from the first captured image. The matching processing unit performs the template matching, using the plurality of template images, to the second captured image after the rotation processing. The specifying unit specifies the displacement angle on basis of a degree of similarity corresponding to each of the plurality of template images according to the template matching.

### Nineteenth Aspect

According to a nineteenth aspect, in the liquid application apparatus of any one of the ninth to eighteenth aspects, the first image processing unit performs the rotation processing on basis of a variable unit rotation amount.

### Twentieth Aspect

According to a twentieth aspect, the liquid application apparatus of any one of the ninth to nineteenth aspects, further includes a position aligner to guide movement of the liquid application apparatus to each of the plurality of regions.

### Twenty-First Aspect

According to a twenty-first aspect, a method for detecting a position of a liquid application apparatus that sequentially moves to each of a plurality of regions (e.g., print regions) in which a region (e.g., liquid application region) to be applied with liquid is divided and discharges liquid on basis of an image pattern (e.g., print image) corresponding to each of the plurality of regions (e.g., print regions) includes acquiring, extracting, performing rotation processing, performing template matching, and specifying. The acquiring acquires a first captured image captured by an imaging unit before movement of the liquid application apparatus to a target region (e.g., target print region) and a second captured image captured by the imaging unit after movement of the liquid application apparatus to the target region. The extracting extracts a template image from the first captured image. The performing rotation processing performs rotation processing to change a relative angle between the second captured image and the template image. The performing template matching performs template matching, using the template image, to the second captured image after the rotation processing. The specifying specifies a relative deviation between before and after the movement of the liquid application apparatus on basis of a position of an image portion, in the second captured image after the rotation processing, which matches or is similar to the template image detected by the template matching.

### Twenty-Second Aspect

According to a twenty-second aspect, a program causes a computer included in a liquid application apparatus that sequentially moves to each of a plurality of regions (e.g., print regions) to which a region (e.g., liquid application region) to be applied with liquid is divided and discharges liquid on basis of an image pattern (e.g., print image) corresponding to each of the plurality of regions (e.g., print regions) to execute acquiring, extracting, performing rotation processing, performing template matching, and specifying. The acquiring acquires a first captured image captured by an imaging unit before movement of the liquid application apparatus to a target region (e.g., target print region) and a second captured image captured by the imaging unit after movement of the liquid application apparatus to the target region. of the extracting extracts a template image from the first captured image. The performing rotation processing performs rotation processing to change a relative angle between the second captured image and the template image. The performing template matching performs template matching, using the template image, to the second captured image after the rotation processing. The specifying specifies a relative deviation between before and after the movement of the liquid application apparatus on basis of a position of an image portion, in the second captured image after the rotation processing, which matches or is similar to the template image detected by the template matching.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A liquid application apparatus to sequentially move to a plurality of regions to which a region to be applied with liquid is divided and discharge liquid on basis of an image pattern corresponding to each of the plurality of regions, the liquid application apparatus comprising:
processing circuitry configured to:
calculate a deviation amount between a first region on which an image pattern is applied by the liquid application apparatus and a second region to which the liquid application apparatus moves from the first region; and
correct an image pattern corresponding to the second region on basis of the deviation amount calculated.

2. The liquid application apparatus according to claim 1,
wherein the processing circuitry is configured to apply liquid on basis of the image pattern corrected.

3. The liquid application apparatus according to claim 1,
wherein the processing circuitry is configured to calculate, as the deviation amount, a displacement amount and a displacement angle of the second region with respect to the first region.

4. The liquid application apparatus according to claim 1,
wherein the processing circuitry is configured to acquire a first captured image captured, in the first region of the liquid application apparatus, by an imaging device and a second captured image captured, in the second region of the liquid application apparatus, by the imaging device,
wherein the processing circuitry is configured to calculate the deviation amount on basis of the first captured image and the second captured image acquired.

5. The liquid application apparatus according to claim 1,
wherein the processing circuitry is configured to:
specify a direction of movement of the liquid application apparatus; and
calculate the deviation amount on basis of the direction of movement specified.

6. A liquid application apparatus to sequentially move to each of a plurality of regions into which a region to be applied with liquid is divided and discharge liquid on basis of an image pattern corresponding to each of the plurality of regions, the liquid application apparatus comprising:
processing circuitry configured to:
acquire a first captured image captured by an imaging device before movement of the liquid application apparatus to a target region and a second captured image captured by the imaging device after the movement of the liquid application apparatus to the target region;
extract a template image from the first captured image;
perform rotation processing to change a relative angle between the second captured image and the template image;
perform template matching, using the template image, to the second captured image after the rotation processing; and
specify a relative deviation between before and after the movement of the liquid application apparatus on basis of a position of an image portion, in the second captured image after the rotation processing, which matches or is similar to the template image detected by the template matching.

7. The liquid application apparatus according to claim 6,
wherein the processing circuitry is configured to:
correct the image pattern to be applied to the target region, on basis of the relative deviation specified; and
apply liquid to the target region on basis of the image pattern corrected.

8. The liquid application apparatus according to claim 6,
wherein the processing circuitry is configured to specify a rotation amount in the rotation processing as a displacement angle of a position of the target region after movement of the liquid application apparatus with respect to a position of the target region of the liquid application apparatus, and as a displacement amount from the target region determined on basis of a position of the image portion detected in the second captured image in the target region included in the second captured image.

9. The liquid application apparatus according to claim 6,
wherein the processing circuitry is configured to perform the rotation processing on the second captured image.

10. The liquid application apparatus according to claim 9,
wherein the processing circuitry is configured to perform the rotation processing on the second captured image by using each of a plurality of rotation amounts.

11. The liquid application apparatus according to claim 6,
wherein the processing circuitry is configured to extract the template image from an image portion of the first captured image overlapping with the second captured image.

12. The liquid application apparatus according to claim 11,
wherein the processing circuitry is configured to extract the template image from the first captured image so that the template image does not include an image pattern that has been applied to a region of the liquid application apparatus before the liquid application apparatus moves to the target region.

13. The liquid application apparatus according to claim 7,
wherein the processing circuitry is configured to acquire the first captured image including the region on which the image pattern is applied, the first captured image being captured by the imaging device after liquid is applied based on the image pattern.

14. The liquid application apparatus according to claim 8,
wherein the processing circuitry is configured to:
extract a plurality of template images, including the template image, from the first captured image;
perform the template matching, using the plurality of template images, to the second captured image after the rotation processing; and
specify the displacement angle on basis of a degree of similarity of the second captured image corresponding to each of the plurality of template images according to the template matching.

15. The liquid application apparatus according to claim 6,
wherein the processing circuitry is configured to perform the rotation processing on basis of a variable unit rotation amount.

16. The liquid application apparatus according to claim 6, further comprising a position aligner to guide movement of the liquid application apparatus to each of the plurality of regions.

17. A liquid application method for a liquid application apparatus to sequentially move to a plurality of regions to which a region to be applied with liquid is divided and discharge liquid on basis of an image pattern corresponding to each of the plurality of regions, the liquid application method comprising:
calculating a deviation amount between a first region on which an image pattern is applied by the liquid application apparatus and a second region to which the liquid application apparatus moves from the first region; and
correcting an image pattern corresponding to the second region on basis of the deviation amount calculated by the calculating.
